(19) United States
(12) Patent Application Publication
(10) Pub. No.: US 2026/0011869 A1
(43) Pub. Date: Jan. 8, 2026

(54) SECONDARY BATTERY AND ELECTRONIC DEVICE

(71) Applicant: Ningde Amperex Technology Limited, Ningde (CN)

(72) Inventors: Xiaohe FAN, Ningde (CN); Zengbin WEI, Ningde (CN)

(73) Assignee: Ningde Amperex Technology Limited, Ningde (CN)

(21) Appl. No.: 19/324,295

(22) Filed: Sep. 10, 2025

Related U.S. Application Data
(63) Continuation of application No. PCT/CN2023/080799, filed on Mar. 10, 2023.

(51) Int. Cl. H01M 50/457; H01M 50/414; H01M 50/417; H01M 50/42; H01M 50/434; H01M 50/446; H01M 50/451; H01M 50/46; H01M 50/489

(52) U.S. Cl. CPC H01M 50/457; H01M 50/414; H01M 50/417; H01M 50/42; H01M 50/434; H01M 50/446; H01M 50/451; H01M 50/461; H01M 50/489

(57) ABSTRACT

A secondary battery includes a positive electrode plate, a negative electrode plate, and a separator, the separator is provided with a first organic coating on a surface facing the positive electrode plate, and the separator is provided with a second organic coating on a surface facing the negative electrode plate, where the first organic coating includes a polymer, and a melting point of the polymer is in a range of 60° C. to 100° C. The secondary battery provided by this application satisfies the above characteristics, widening a hot-box window and enhancing safety performance without affecting cycling performance of the secondary battery.

### CROSS-REFERENCE TO RELATED APPLICATIONS

This application is a continuation application of International Application No. PCT/CN2023/080799, filed on Mar. 10, 2023, the content of which is incorporated herein by reference in its entirety.

### TECHNICAL FIELD

This application relates to the field of electrochemical technologies, and in particular, to a secondary battery and an electronic device.

### BACKGROUND

Fast charge and high energy density are significant trends in the development of secondary batteries. With the rapid increase in a charge rate and energy density of secondary batteries, safety issues of secondary batteries have become increasingly prominent, with a hot-box window of secondary batteries becoming narrower.

Currently, a solution to the above issue is mainly to adjust an electrolyte solvent system and use low-adhesion polyvinylidene fluoride (PVDF) coatings. However, adjusting the electrolyte solvent system degrades cycling performance of secondary batteries; and using polyvinylidene fluoride (PVDF) coatings leads to poor interfacial adhesion in secondary batteries, causing deformation of the secondary batteries after charge/discharge cycles. Therefore, how to widen the hot-box window and enhance safety performance of secondary batteries without affecting the cycling performance has become an urgent technical problem to be solved by persons skilled in the art.

### SUMMARY

The purpose of this application is to provide a secondary battery and an electronic device, so as to widen a hot-box window and enhance safety performance without affecting cycling performance of the secondary battery. The specific technical solutions are as follows.

A first aspect of this application provides a secondary battery, including a positive electrode plate, a negative electrode plate, and a separator, where the separator is provided with a first organic coating on a surface facing the positive electrode plate, and the separator is provided with a second organic coating on a surface facing the negative electrode plate; where the first organic coating includes a polymer, and a melting point of the polymer is in a range of 60° C. to 100° C. The separator in the secondary battery provided by this application satisfies the above characteristics, widening a hot-box window and enhancing safety performance without affecting cycling performance of the secondary battery.

In some embodiments of this application, the melting point of the polymer is preferably in a range of 60° C. to 90° C., and more preferably, 60° C. to 80° C.

In some embodiments of this application, the melting point of the polymer is in a range of 70° C. to 80° C.

In some embodiments of this application, Dᵥ50 of the polymer is in a range of 0.8 μm to 2 μm, and preferably, 1.0 μm to 1.5 μm.

In some embodiments of this application, the polymer includes a polymer of at least one monomer selected from the group consisting of ethylene, propylene, vinylidene fluoride, acrylic acid, acrylate, styrene, acrylonitrile, maleic anhydride, vinyl chloride, and chloropropene; and the polymer is a homopolymer, a copolymer, or a blend.

In some embodiments of this application, the polymer includes a graft copolymer, where a monomer of a polymer backbone in the graft copolymer includes at least one selected from the group consisting of ethylene, propylene, vinylidene fluoride, acrylic acid, acrylate, styrene, acrylonitrile, maleic anhydride, vinyl chloride, and chloropropene, and a monomer used for grafting includes at least one selected from the group consisting of maleic anhydride, acrylate, and acrylic acid.

In some embodiments of this application, based on a total mass of the polymer, a proportion of the monomer used for grafting is 1% to 10%.

In some embodiments of this application, a mass average molar mass of the polymer is 300000 to 1000000.

In some embodiments of this application, a room-temperature adhesion strength at 25° C. between the first organic coating and a positive electrode active material layer on the positive electrode plate is T1, and a high-temperature adhesion strength at 130° C. between the first organic coating and the positive electrode active material layer on the positive electrode plate is T2, where 0≤T2/T1≤0.8.

In some embodiments of this application, T1 is 7 N/m to 13 N/m, and T2 is 1 N/m to 3 N/m.

In some embodiments of this application, a high-temperature adhesion strength at 130° C. between the second organic coating and a negative electrode active material layer on the negative electrode plate is T3, where T3−T2≥5 N/m, and preferably, T3−T2≥12 N/m.

In some embodiments of this application, a coating weight of the first organic coating is 0.5 mg/5000 mm² to 3 mg/5000 mm², preferably, 0.5 mg/5000 mm² to 1.5 mg/5000 mm².

In some embodiments of this application, a coating thickness of the first organic coating is 0.5 μm to 5 μm.

In some embodiments of this application, an inorganic coating is provided between a separator substrate and the first organic coating.

In some embodiments of this application, the inorganic coating includes ceramic, and the ceramic includes at least one selected from the group consisting of aluminum oxide, boehmite, titanium dioxide, silicon dioxide, zirconium dioxide, tin dioxide, magnesium hydroxide, magnesium oxide, zinc oxide, barium sulfate, boron nitride, and aluminum nitride.

A second aspect of this application provides an electronic device, including the secondary battery according to any one of the foregoing embodiments. Therefore, the electronic device provided in this application exhibits good performance.

Beneficial effects of this application are as follows.

This application provides a secondary battery and an electronic device, where the secondary battery includes a positive electrode plate, a negative electrode plate, and a separator, the separator is provided with a first organic coating on a surface facing the positive electrode plate, and the separator is provided with a second organic coating on a surface facing the negative electrode plate, where the first organic coating includes a polymer, and a melting point of the polymer is in a range of 60° C. to 100° C. The secondary battery provided by this application satisfies the above characteristics, widening a hot-box window and enhancing safety performance without affecting cycling performance of the secondary battery.

### BRIEF DESCRIPTION OF DRAWINGS

To more clearly illustrate technical solutions in some embodiments of this application or the prior art, drawings required for describing these embodiments or the prior art are briefly introduced below. It is clear that the drawings below merely describe some embodiments of this application, and persons of ordinary skill in the art can obtain other embodiments based on these drawings.

FIG. 1 is a schematic structural diagram of a separator in Example 1 of this application;

FIG. 2 a schematic diagram illustrating a process of interfacial detachment of a first organic coating at a high temperature according to an embodiment of this application;

FIG. 3 is an infrared absorption spectrum of a polymer in Example 1 of this application; and

FIG. 4 is a schematic structural diagram of a separator in Example 6 of this application.

### DETAILED DESCRIPTION

To make the objectives, technical solutions, and advantages of this application clearer, this application is further described in detail below with reference to the drawings and embodiments. It is clear that the described embodiments are merely some but not all embodiments of this application. All other embodiments obtained by persons of ordinary skill in the art based on these embodiments in this application fall within the protection scope of this application.

It should be noted that in the following descriptions, an example in which a lithium-ion battery is used as a secondary battery is used to illustrate this application. However, the secondary battery of this application is not limited to the lithium-ion battery. Specific technical solutions are as follows.

A first aspect of this application provides a secondary battery, including a positive electrode plate, a negative electrode plate, and a separator, where the separator is provided with a first organic coating on a surface facing the positive electrode plate, and the separator is provided with a second organic coating on a surface facing the negative electrode plate, where the first organic coating includes a polymer, and a melting point of the polymer is in a range of 60° C. to 100° C.

The inventors have found that a hot-box failure of a secondary battery can be divided into three stages: heat generation, heat accumulation, and thermal runaway. An SEI film decomposes and generates heat at 50° C. to 80° C. A fully charged positive electrode reacts with an electrolyte and begins heat accumulation at 100° C., a positive electrode accelerates heat generation at 140° C., a negative electrode undergoes thermal runaway at 180° C., and the electrolyte catches fire and burns at 220° C. During the process of hot-box failure, the positive electrode first undergoes heat accumulation. To widen a hot-box window and enhance safety performance, the first organic coating in the separator of this application includes a polymer with a melting point of 60° C. to 100° C. This polymer is a low-melting-point polymer that has high adhesion at room temperature, satisfying adhesion requirements during cycling. The polymer also has a thermal debonding property, meaning that adhesion weakens at a high temperature, resulting in interfacial detachment of the first organic coating from the positive electrode plate or a separator substrate at a high temperature. This helps reduce heat accumulation, widen the hot-box window, and enhance safety performance. When the first organic coating includes a polymer with a melting point of 60° C. to 100° C., the hot-box window can be widened, and safety performance can be enhanced without affecting cycling performance of the secondary battery. For example, FIG. 2 is a schematic diagram illustrating a process of interfacial detachment of a first organic coating at a high temperature according to an embodiment of this application. The separator includes a first organic coating 1, a second organic coating 2, an inorganic coating 3, and a separator substrate 4.

Specifically, the melting point of the polymer in the first organic coating may be 60° C., 65° C., 70° C., 75° C., 80° C., 85° C., 90° C., 95° C., 100° C., or may be in a range defined by any two of the above values. Preferably, the melting point of the polymer in the first organic coating is 60° C. to 90° C. More preferably, the melting point of the polymer in the first organic coating is 60° C. to 80° C. In some embodiments, the melting point of the polymer in the first organic coating is 70° C. to 80° C. When the melting point of the polymer in the first organic coating is excessively low, for example, below 60° C., since a coating temperature of the organic coating is 50° C. to 55° C., the polymer tends to melt easily, leading to high fluidity and easy clogging of pores. Although the thermal debonding effect is good, kinetic performance decreases, resulting in poorer cycling performance. When the melting point of the polymer in the first organic coating is excessively high, for example, above 100° C., the polymer is less likely to melt, resulting in poor thermal debonding performance and a lower hot-box pass rate. By controlling the melting point of the polymer in the first organic coating within the above range, the hot-box window can be widened, and safety performance can be enhanced without affecting the cycling performance of the secondary battery.

In the secondary battery provided by this application, a separator is provided with a first organic coating on a surface facing the positive electrode plate and a second organic coating on a surface facing the negative electrode plate, where the first organic coating includes a polymer with a melting point of 60° C. to 100° C., widening the hot-box window and enhancing safety performance without affecting the cycling performance of the secondary battery.

In some embodiments of this application, Dᵥ50 of the polymer is in a range of 0.8 μm to 2 μm, and preferably, Dᵥ50 of the polymer is in a range of 1.0 μm to 1.5 μm. For example, the Dᵥ50 may be 0.8 μm, 0.9 μm, 1.0 μm, 1.1 μm, 1.2 μm, 1.3 μm, 1.4 μm, 1.5 μm, 1.6 μm, 1.7 μm, 1.8 μm, 1.9 μm, 2 μm, or may be in a range defined by any two of the above values. When the Dᵥ50 of the polymer is excessively small, for example, less than 0.8 μm, an electrolyte transport capability is poor, and the thermal debonding performance is weakened, leading to poor cycling performance and a lower hot-box pass rate. When the Dᵥ50 of the polymer is excessively large, for example, greater than 2 μm, room-temperature adhesion is excessively low, and the secondary battery is prone to deformation during cycling, resulting in poor cycling performance.

In this application, Dᵥ50 is a particle size of a material where the cumulative distribution by volume reaches 50% as counted from the small particle size side, and Dᵥ99 is a particle size of a material where the cumulative distribution by volume reaches 99% as counted from the small particle size side.

In some embodiments of this application, the polymer includes a polymer of at least one monomer selected from the group consisting of ethylene, propylene, vinylidene fluoride, acrylic acid, acrylate, styrene, acrylonitrile, maleic anhydride, vinyl chloride, and chloropropene, and the polymer is a homopolymer, a copolymer, or a blend. For example, the monomer of a polymer backbone in the copolymer includes propylene and ethylene, with a proportion of propylene being 80% to 90% and a proportion of ethylene being 10% to 20%. For example, the proportion of propylene may be 80%, 82%, 85%, 88%, 90%, or may be in a range defined by any two of the above values, and the proportion of ethylene may be 10%, 12%, 14%, 15%, 17%, 20%, or may be in a range defined by any two of the above values.

In some embodiments of this application, the polymer includes a graft copolymer, where a monomer of a polymer backbone in the graft copolymer includes at least one selected from the group consisting of ethylene, propylene, vinylidene fluoride, acrylic acid, acrylate, styrene, acrylonitrile, maleic anhydride, vinyl chloride, and chloropropene, and a monomer used for grafting includes at least one selected from the group consisting of maleic anhydride, acrylate, and acrylic acid. For example, a polymer backbone in the graft copolymer includes propylene and ethylene, with a proportion of propylene being 80% to 90% and a proportion of ethylene being 10% to 20%. For example, the proportion of propylene may be 80%, 82%, 85%, 88%, 90%, or may be in a range defined by any two of the above values, and the proportion of ethylene may be 10%, 12%, 14%, 15%, 17%, 20%, or may be in a range defined by any two of the above values. The monomer used for grafting includes maleic anhydride. By selecting the above types of grafting monomer, the graft copolymer becomes a polar copolymer, improving electrolyte infiltration in the separator, thereby enhancing the cycling performance.

In some embodiments of this application, the polymer exhibits an absorption peak at one or more of wavenumbers 2957 cm⁻¹, 2916 cm⁻¹, 2866 cm⁻¹, 2838 cm⁻¹, 1457 cm⁻¹, or 1376 cm⁻¹, where 2957 cm⁻¹ is an asymmetric stretching vibration peak of methyl, 2916 cm⁻¹ is an asymmetric stretching vibration peak of methylene, 2866 cm⁻¹ is a symmetric stretching vibration peak of methyl, 2838 cm⁻¹ is a symmetric stretching vibration peak of methylene, 1457 cm⁻¹ is a bending vibration peak of methylene, and 1376 cm⁻¹ is a bending vibration peak of methyl, indicating that a main chain of the polymer is polymerized from at least one selected from the group consisting of ethylene, propylene, vinyl chloride, and chloropropene; furthermore, the polymer exhibits an absorption peak at a wavenumber of 1712±50 cm⁻¹, where 1712±50 cm⁻¹ is a stretching vibration peak of carbonyl, indicating that the polymer is grafted with at least one selected from the group consisting of maleic anhydride, acrylate, and acrylic acid. When the polymer satisfies the above requirements, it indicates that the polymer has a polar functional group and can improve electrolyte infiltration, and enhancing cycling performance. For example, FIG. 3 is an infrared absorption spectrum of the polymer in Example 1 of this application.

In some embodiments of this application, based on a total mass of the polymer, a proportion of the monomer used for grafting is 1% to 10%. For example, the proportion of the monomer used for grafting may be 1%, 2%, 3%, 4%, 5%, 6%, 7%, 8%, 9%, 10%, or may be in a range defined by any two of the above values. When the proportion of the monomer used for grafting is excessively low, for example, below 1%, improvement in the cycling performance is insignificant. When the proportion of the monomer used for grafting is excessively high, for example, above 10%, the melting point of the polymer may increase, affecting the hot-box pass rate.

In some embodiments of this application, a mass average molar mass of the polymer is 300000 to 1000000. For example, the mass average molar mass of the polymer may be 300000, 350000, 400000, 450000, 500000, 550000, 600000, 650000, 700000, 750000, 800000, 850000, 900000, 950000, 1000000, or may be in a range defined by any two of the above values. When the mass average molar mass of the polymer is excessively low, for example, below 300000, the separator may experience pore clogging, leading to poor cycling performance. When the mass average molar mass of the polymer is excessively high, for example, above 1000000, a failure effect of the separator is reduced, affecting the hot-box pass rate.

In some embodiments of this application, a room-temperature adhesion strength at 25° C. between the first organic coating and a positive electrode active material layer on the positive electrode plate is T1, and a high-temperature adhesion strength at 130° C. between the first organic coating and the positive electrode active material layer on the positive electrode plate is T2, where 0≤T2/T1≤0.8. For example, a value of T2/T1 may be 0, 0.1, 0.2, 0.3, 0.4, 0.5, 0.6, 0.7, 0.8, or may be in a range defined by any two of the above values.

In some embodiments of this application, T1 is 7 N/m to 13 N/m, and T2 is 1 N/m to 3 N/m. For example, T1 may be 7 N/m, 7.5 N/m, 8 N/m, 8.5 N/m, 9 N/m, 9.5 N/m, 10 N/m, 10.5 N/m, 11 N/m, 11.5 N/m, 12 N/m, 12.5 N/m, 13 N/m, or may be in a range defined by any two of the above values, and T2 may be 1 N/m, 1.2 N/m, 1.4 N/m, 1.6 N/m, 1.8 N/m, 2 N/m, 2.2 N/m, 2.4 N/m, 2.6 N/m, 2.8 N/m, 3 N/m, or may be in a range defined by any two of the above values. Controlling the adhesion strength between the organic coating and the positive electrode plate within the above range can ensure the room-temperature adhesion strength between the separator and the positive electrode plate, improving hot-box pass rate.

In some embodiments of this application, a high-temperature adhesion strength at 130° C. between the second organic coating and the negative electrode active material layer on the negative electrode plate is T3, and a room-temperature adhesion strength at 25° C. between the second organic coating and a negative electrode active material layer on the negative electrode plate is T4, where T3−T2≥5 N/m, and preferably T3−T2≥12 N/m. For example, the value of T3−T2 may be 5 N/m, 6 N N/m, 7 N/m, 8 N/m, 9 N/m, 10 N/m, 11 N/m, 12 N/m, 13 N/m, 14 N/m, 15 N/m, 16 N/m, 17 N/m, 18 N/m, or may be in a range defined by any two of the above values. By adjusting a coating weight of the second organic coating, the second organic coating maintains high adhesion to the negative electrode plate at both room temperature and high temperature, with minimal change in the adhesion strength between the second organic coating and the negative electrode plate, for example, 20 N at a room temperature and 18 N in a 120° C. to 140° C. environment. Preferably, the second organic coating is a high-adhesion coating, so that at high temperatures, the first organic coating detaches from the positive electrode plate or the separator first. A greater the difference in adhesion strength between the two at high temperatures means higher selectivity of detaching from the positive electrode plate by the separator. For example, the polymer type of the second organic coating may be at least one selected from the group consisting of polyethylene, polypropylene, polyvinylidene fluoride, polyacrylic acid, polyacrylate, polystyrene, polyacrylonitrile, polymaleic anhydride, polyvinyl chloride, and polychloropropene, and the polymer of the second organic coating may be a homopolymer, a copolymer, or a blend. A coating weight of the second organic coating may be 0.5 mg/5000 mm² to 3 mg/5000 mm². A coating thickness of the second organic coating may be 0.5 μm to 5 μm. A preparation method of a second organic coating slurry is not particularly limited in this application.

In some embodiments of this application, a coating weight of the first organic coating is 0.5 mg/5000 mm² to 3 mg/5000 mm², and preferably, the coating weight of the first organic coating is 0.5 mg/5000 mm² to 1.5 mg/5000 mm². Specifically, the coating weight of the first organic coating may be 0.5 mg/5000 mm², 1 mg/5000 mm², 1.5 mg/5000 mm², 2 mg/5000 mm², 2.5 mg/5000 mm², 3 mg/5000 mm², or may be in a range defined by any two of the above values. When the coating weight of the first organic coating is excessively low, for example, below 0.5 mg/5000 mm², the adhesion of the separator is poor, and the secondary battery is prone to deformation during cycling, resulting in poor cycling performance. When the coating weight of the first organic coating is excessively high, for example, above 3 mg/5000 mm², since a coating temperature of the separator is close to the melting point of the polymer, the polymer may partially soften, causing adjacent polymers to stick together, leading to pore clogging and poor cycling performance.

In some embodiments of this application, a coating thickness of the first organic coating is 0.5 μm to 5 μm. For example, the coating thickness of the first organic coating may be 0.5 μm, 1 μm, 1.5 μm, 2 μm, 2.5 μm, 3 μm, 3.5 μm, 4 μm, 4.5 μm, 5 μm, or may be in a range defined by any two of the above values. When the coating thickness of the first organic coating is excessively small, for example, below 0.5 μm, the adhesion of the separator is poor, and the secondary battery is prone to deformation during cycling, resulting in poor cycling performance. When the coating thickness of the first organic coating is excessively large, for example, above 5 μm, the polymer may partially soften, causing adjacent polymers to stick together, leading to pore clogging and poor cycling performance.

In some embodiments of this application, an inorganic coating is provided between the separator substrate and the first organic coating. By providing an inorganic coating between the separator substrate and the first organic coating, the thermal shrinkage performance, puncture resistance, and electrolyte transport performance of the separator can be improved.

In some embodiments of this application, the inorganic coating includes ceramic, and the ceramic includes at least one selected from the group consisting of aluminum oxide, boehmite, titanium dioxide, silicon dioxide, zirconium dioxide, tin dioxide, magnesium hydroxide, magnesium oxide, zinc oxide, barium sulfate, boron nitride, and aluminum nitride.

A preparation method of the first organic coating slurry is not particularly limited in this application. For example, the preparation method of the first organic coating slurry may include, but is not limited to, the following steps: adding the polymer to a mixer and stirring uniformly; adding a thickener to the above slurry and stirring uniformly; adding a wetting agent; finally adding deionized water to adjust a viscosity of the slurry to obtain the organic coating slurry. A ratio of the added polymer, thickener, and wetting agent may be (80 to 95):(0.5 to 5):(0.5 to 10). The thickener is not particularly limited in this application, and may be, for example, at least one selected from the group consisting of sodium carboxymethyl cellulose, hydroxyethyl cellulose, hydroxypropyl methyl cellulose, methyl hydroxyethyl cellulose, and ethyl hydroxyethyl cellulose. The wetting agent is not particularly limited in this application, and may be, for example, at least one selected from the group consisting of polyoxyethylene ether, sucrose ester, and sodium alkyl ether sulfate.

A preparation process of the polymer in the first organic coating is not particularly limited in this application as long as the objectives of this application can be achieved. For example, a preparation process of the polymer in the first organic coating is as follows: feeding a resin and a solvent in a weight ratio of (2 to 4):(6 to 8) into a reactor (with a water separator), stirring at 120° C. to 140° C. for 2 h to 6 h at a speed of 20 rpm to 80 rpm to obtain a first solution; stirring an emulsifier and deionized water at room temperature for 30 min to 60 min at a speed of 20 rpm to 80 rpm to obtain a second solution; stirring the first solution and the second solution at room temperature for 5 min to 10 min at a speed of 1000 rpm to 1500 rpm to obtain a preliminary emulsion; and transferring the preliminary emulsion to a homogenizer and homogenizing at a pressure of 400 bar to 600 bar to obtain the polymer. In this application, the resin is a copolymer synthesized from the monomer of the polymer in the first organic coating and the monomer used for grafting in a required ratio. The solvent is not particularly limited in this application, and may be, for example, at least one selected from the group consisting of methylcyclohexane, pentane, formic acid, acetone, anisole, and ethyl acetate. The emulsifier is not particularly limited in this application, and may be, for example, a commonly used emulsifier in the art, such as one or more of N-dodecyldimethylamine, cetyltrimethylammonium bromide, dodecylammonium chloride, or cetylpyridinium bromide.

A method for adjusting the melting point of the above polymer is not particularly limited in this application as long as the objectives of this application can be achieved. For example, the melting point of the above polymer can be adjusted by adjusting the molecular weight, the proportion of polymer monomers, and the proportion of monomer used for grafting.

In this application, the inorganic coating further includes a binder. The binder is not particularly limited in this application, and may be, for example, at least one and polyacrylate, polyimide, polyamide, polyamide-imide, polyvinylidene fluoride, polystyrene-butadiene copolymer (styrene-butadiene rubber), sodium alginate, polyvinyl alcohol, polytetrafluoroethylene, polyacrylonitrile, sodium carboxymethyl cellulose, potassium carboxymethyl cellulose, sodium hydroxymethyl cellulose, or potassium hydroxymethyl cellulose.

A thickness of the inorganic coating is not particularly limited in this application as long as the objectives of this application can be achieved. For example, the thickness of the inorganic coating is 0.5 μm to 6 μm.

A coating weight of the inorganic coating is not particularly limited in this application as long as the objectives of this application can be achieved. For example, the coating weight of the inorganic coating is 3 mg/5000 mm² to 20 mg/5000 mm². A preparation method of the inorganic coating is not particularly limited in this application as long as the objectives of this application can be achieved.

The separator substrate is not particularly limited in this application as long as the objectives of this application can be achieved. For example, the separator substrate may be a non-woven fabric, a film, or a composite film with a porous structure, and the material of the separator substrate may include at least one selected from the group consisting of polyethylene, polypropylene, polyethylene terephthalate, polyimide, polyamide, spandex, and aramid. Optionally, a polypropylene porous film, a polyethylene porous film, a polypropylene non-woven fabric, a polyethylene non-woven fabric, or a polypropylene-polyethylene-polypropylene porous composite film can be used.

In this application, the secondary battery further includes a positive electrode plate, where the positive electrode plate includes a positive electrode current collector and a positive electrode material layer disposed on at least one surface of the positive electrode current collector. The phrase “positive electrode material layer disposed on at least one surface of the positive electrode current collector” means that the positive electrode material layer may be disposed on one surface of the positive electrode current collector in a thickness direction of the positive electrode current collector or on both surfaces of the positive electrode current collector in the thickness direction. It should be noted that the “surface” herein may be an entire region or a partial region of the positive electrode current collector. This is not particularly limited in this application as long as the objectives of this application can be achieved. The positive electrode current collector is not particularly limited in this application as long as the objectives of this application can be achieved. For example, the positive electrode current collector may include an aluminum foil, aluminum alloy foil, a composite current collector (for example, an aluminum-carbon composite current collector), or the like. The positive electrode material layer includes a positive electrode active material, and the positive electrode active material is not particularly limited in this application as long as the objectives of this application can be achieved. For example, the positive electrode active material may include at least one selected from the group consisting of lithium nickel manganese cobalt oxide (common examples are NCM811, NCM622, NCM523, and NCM111), lithium nickel cobalt aluminum oxide, lithium iron phosphate, lithium-rich manganese-based material, lithium cobalt oxide (LiCoO₂), lithium manganate oxide, lithium manganese iron phosphate, and lithium titanate. The positive electrode material layer further includes a conductive agent and a binder. Types of the conductive agent and the binder are not particularly limited as long as the objectives of this application can be achieved. For example, the binder may be at least one of the binders mentioned above, and the conductive agent may include at least one selected from the group consisting of acetylene black, conductive carbon black (Super P), carbon nanotubes (CNTs), carbon fibers, flake graphite, Ketjen black, and graphene. A mass ratio of the positive electrode active material, the conductive agent, and the binder in the positive electrode material layer is not particularly limited in this application, and persons skilled in the art can make selections based on actual needs, as long as the objectives of this application can be achieved. Thicknesses of the positive electrode current collector and the positive electrode material layer are not particularly limited in this application as long as the objectives of this application can be achieved. For example, the thickness of the positive electrode current collector is 6 μm to 12 μm, and the thickness of the positive electrode material layer is 30 μm to 120 μm. Thickness of the positive electrode plate is not particularly limited in this application as long as the objectives of this application can be achieved. For example, the thickness of the positive electrode plate is 50 μm to 250 μm.

In this application, the secondary battery further includes a negative electrode plate, where the negative electrode plate may include a negative electrode current collector and a negative electrode active material layer disposed on at least one surface of the negative electrode current collector. The negative electrode current collector is not particularly limited in this application as long as the objectives of this application can be achieved, and may include, for example, a copper foil, copper alloy foil, nickel foil, stainless steel foil, titanium foil, nickel foam, copper foam, or a composite current collector. The negative electrode active material layer in this application includes a negative electrode active material, a conductive agent, and a thickener. The negative electrode active material in this application may include at least one selected from the group consisting of natural graphite, artificial graphite, mesocarbon microbeads (MCMB), hard carbon, soft carbon, silicon, silicon-carbon composite, SiOₓ (0.5<x<1.6), Li—Sn alloy, Li—Sn—O alloy, Sn, SnO, SnO₂, spinel-structure lithium titanate Li₄Ti₅O₁₂, Li—Al alloy, and metallic lithium. In this application, thicknesses of the negative electrode current collector and the negative electrode active material layer is not particularly limited as long as the objectives of this application can be achieved. For example, the thickness of the negative electrode current collector is 6 μm to 10 μm, and the thickness of the negative electrode active material layer is 30 μm to 120 μm. A thickness of the negative electrode plate is not particularly limited in this application as long as the objectives of this application can be achieved. For example, the thickness of the negative electrode plate is 50 μm to 250 μm.

The secondary battery in this application further includes an electrolyte, where the electrolyte includes a lithium salt and a non-aqueous solvent. The lithium salt may include various lithium salts commonly used in the art, for example, at least one selected from the group consisting of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalato)borate (LiBOB), and lithium difluoroborate. A concentration of the lithium salt in the electrolyte is not particularly limited in this application as long as the objectives of this application can be achieved. For example, the concentration of the lithium salt in the electrolyte is 0.9 mol/L to 1.5 mol/L. For example, the concentration of the lithium salt in the electrolyte may be 0.9 mol/L, 1.0 mol/L, 1.1 mol/L, 1.3 mol/L, 1.5 mol/L, or may be in a range defined by any two of the above values. The non-aqueous solvent is not particularly limited in this application as long as the objectives of this application can be achieved, and for example, may include, but is not limited to, at least one selected from the group consisting of a carbonate compound, carboxylate compound, ether compound, and another organic solvent. The carbonate compound may include, but is not limited to, at least one selected from the group consisting of a linear carbonate compound, a cyclic carbonate compound, and a fluorocarbonate compound. The linear carbonate compound may include, but is not limited to, at least one selected from the group consisting of dimethyl carbonate (DMC), diethyl carbonate (DEC), dipropyl carbonate (DPC), methyl propyl carbonate (MPC), ethylene propyl carbonate (EPC), and methyl ethyl carbonate (MEC). The cyclic carbonate may include, but is not limited to, at least one selected from the group consisting of ethylene carbonate (EC), propylene carbonate (PC), butylene carbonate (BC), and vinyl ethylene carbonate (VEC). The fluorocarbonate compound may include, but is not limited to, at least one selected from the group consisting of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, and trifluoromethylethylene carbonate. The carboxylate compound may include, but is not limited to, at least one selected from the group consisting of methyl formate, methyl acetate, ethyl acetate, n-propyl acetate, tert-butyl acetate, methyl propionate, ethyl propionate, propyl propionate, γ-butyrolactone, decanolide, valerolactone, and caprolactone. The ether compound may include, but is not limited to, at least one selected from the group consisting of dibutyl ether, etraethylene glycol dimethyl ether, diethylene glycol dimethyl ether, 1,2-dimethoxyethane, 1,2-diethoxyethane, 1-ethoxy-1-methoxyethane, 2-methyltetrahydrofuran, and tetrahydrofuran. The another organic solvent may include, but is not limited to, at least one selected from the group consisting of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, and trioctyl phosphate.

The secondary battery in this application further includes a packaging bag for accommodating the positive electrode plate, the separator, the negative electrode plate, the electrolyte, and other known components of the secondary battery in the art. The other components are not limited in this application. The packaging bag is not particularly limited in this application and may be any well-known packaging bag in the art as long as the objectives of this application can be achieved.

The secondary battery in this application is not particularly limited and may include any device in which an electrochemical reaction occurs. In some embodiments, the secondary battery may include, but is not limited to, a lithium metal secondary battery, a lithium-ion secondary battery (lithium-ion battery), a lithium polymer secondary battery, or a lithium-ion polymer secondary battery.

A preparation process of the secondary battery in this application is well known to persons skilled in the art and is not particularly limited in this application. For example, the preparation process may include, but is not limited to, the following steps: stacking a positive electrode plate, a separator, and a negative electrode plate in sequence, winding and folding a resulting stack as required to obtain an electrode assembly of a wound structure, placing the electrode assembly into a packaging bag, injecting an electrolyte into the packaging bag, and then sealing the packaging bag to obtain a secondary battery; alternatively, stacking a positive electrode plate, a separator, and a negative electrode plate in sequence, fixing four corners of the entire laminated structure with tapes to obtain an electrode assembly of the laminated structure, placing the electrode assembly into a packaging bag, injecting an electrolyte into the packaging bag, and then sealing the packaging bag to obtain a secondary battery. In addition, an overcurrent prevention element, a guide plate, and the like may be placed in the packaging bag as required to prevent pressure increase, overcharge, and over-discharge in the secondary battery.

A second aspect of this application provides an electronic device, including the secondary battery according to any one of the foregoing embodiments. Therefore, the electronic device provided in this application exhibits good performance.

The electronic device in this application is not particularly limited and may be any electronic device known in the prior art. In some embodiments, the electronic device may include, but is not limited to, a notebook computer, a pen-input computer, a mobile computer, an electronic book player, a portable telephone, a portable fax machine, a portable copier, a portable printer, a headset, a video recorder, a liquid crystal television, a portable cleaner, a portable CD player, a mini disc, a transceiver, an electronic notebook, a calculator, a memory card, a portable recorder, a radio, a backup power supply, a motor, an automobile, a motorcycle, an electric bicycle, a bicycle, a lighting appliance, a toy, a game console, a clock, a power tool, a flash lamp, a camera, a large household battery, or a lithium-ion capacitor.

### EXAMPLES

Examples and comparative examples are provided below to further illustrate these embodiments of this application. Various tests and evaluations are conducted according to the methods described below. In addition, unless otherwise specified, “part” and “%” are based on weight.

### Test Methods and Equipment

### Melting Point Test

A secondary battery was disassembled, and a separator was removed. A coating on a surface of the separator was scraped off with a blade, and a melting point was tested using a differential scanning calorimeter (DSC). A sample weight was 8 mg to 15 mg, a range of test temperature was room temperature to 400° C., and a heating rate was 10° C./min.

### Adhesion Strength Test

A secondary battery was disassembled to obtain a separator, a positive electrode plate, and a negative electrode plate. The separator, the positive electrode plate, and negative electrode plate were cut into 54.2 mm×72.5 mm samples. The separator was composited with a cathode/anode through hot pressing by a hot press machine under conditions of 85° C., 1 MPa, and 85 s. The composited sample was cut into a 15 mm×54.2 mm strip, and the adhesion strength was tested at room temperature (25° C.) and high temperature (130° C.) according to the 180° peel strength test standard.

### Cycling Capacity Retention Rate Test

A test temperature was 12° C., and the test procedure was as follows: (1) a battery was left standby for 5 min; (2) charged at a constant current of 2C to 4.45V, and then charged at a constant voltage to 0.05 C; (3) left standby for 5 min; (4) discharged at a constant current of 0.2 C to 3.0V; (5) left standby for 5 min; (6) charged at a constant current of 2C to 4.45V, and then charged at a constant voltage to 0.05 C; (7) left standby for 5 min; (8) discharged at a constant current of 1C to 3.0V; (9) left standby for 5 min followed by repeating steps (6) to (9) for 49 cycles; (10) charged at a constant current of 2C to 4.45V, and then charged at a constant voltage to 0.05 C; (11) left standby for 5 min; (12) discharged at a constant current of 0.2 C to 3.0V; (13) left standby for 5 min followed by repeating steps (10) to (13) for 800 cycles; and a discharge capacity at the first cycle and a discharge capacity at the 800th cycle of the lithium-ion battery were recorded.

Cycling capacity retention rate (%) of lithium-ion battery=(discharge capacity at the 800th cycle/discharge capacity at the first cycle)×100%.

### Hot-Box Test

A lithium-ion battery was first pretreated as follows: at a test temperature of 20° C.±5° C., left standing for 5 min, charged at a constant current of 0.5 C to 4.5V, then charged at a constant voltage of 4.5V to 0.025C, and left standing for 60 min. Then, the hot-box test was conducted: an appearance of the lithium-ion battery was inspected and photographed before the test, a temperature sensor wire was attached, and the sample was placed vertically in a chamber and heated at a rate of 5±2° C./min to a test temperature (130° C. to 140° C.) with the temperature held for 60 min. A voltage and an internal resistance were measured. If the lithium-ion battery did not catch fire or explode, the hot-box test was passed.

### Example 1

### <Preparation of Separator>

### Preparation of Inorganic Coating

Boehmite, acrylic acid, and sodium carboxymethyl cellulose were dispersed in deionized water at a mass ratio of 94.5:5:0.5 and stirred uniformly until a slurry viscosity stabilized, obtaining a suspension with a solid content of 40% as a raw material. The ceramic slurry was applied to a surface of a separator substrate (5-μm polyethylene (PE)) facing the positive electrode by using a micro-gravure coating method, forming an inorganic coating with a thickness of 2 μm.

### Preparation of First Organic Coating

A resin (a copolymer synthesized from, by mass percentage, 10% ethylene, 85% propylene, and 5% maleic anhydride) and a methylcyclohexane solution (methylcyclohexane dissolved in water with mass percentage being 15%) were fed into a reactor (with a water separator) in a weight ratio of 3:7, stirred at 130° C. for 4 h at a speed of 50 rpm to obtain a first solution. N-dodecyldimethylamine, cetyltrimethylammonium bromide, and deionized water were stirred at room temperature for 30 min at a speed of 50 rpm to obtain a second solution. The first solution and the second solution were stirred at room temperature for 5 min at a speed of 1000 rpm to obtain a preliminary emulsion. The preliminary emulsion was transferred to a homogenizer and homogenized at a pressure of 500 bar to obtain the polymer.

The above polymer was added to a mixer and stirred uniformly. Sodium carboxymethyl cellulose was added to the above slurry and stirred uniformly. Polyoxyethylene ether was added. A ratio of the added polymer, sodium carboxymethyl cellulose, and polyoxyethylene ether was 91:0.5:8.5. Finally, deionized water was added to adjust a viscosity of the first organic coating slurry to 40 mPa s with a solid content of 5%, obtaining the first organic coating slurry. The first organic coating slurry was uniformly applied to the inorganic coating, dried in an oven, with a coating weight of the first organic coating being 1.5 mg/5000 mm² and a coating thickness of the first organic coating being 1 μm.

### Preparation of Second Organic Coating

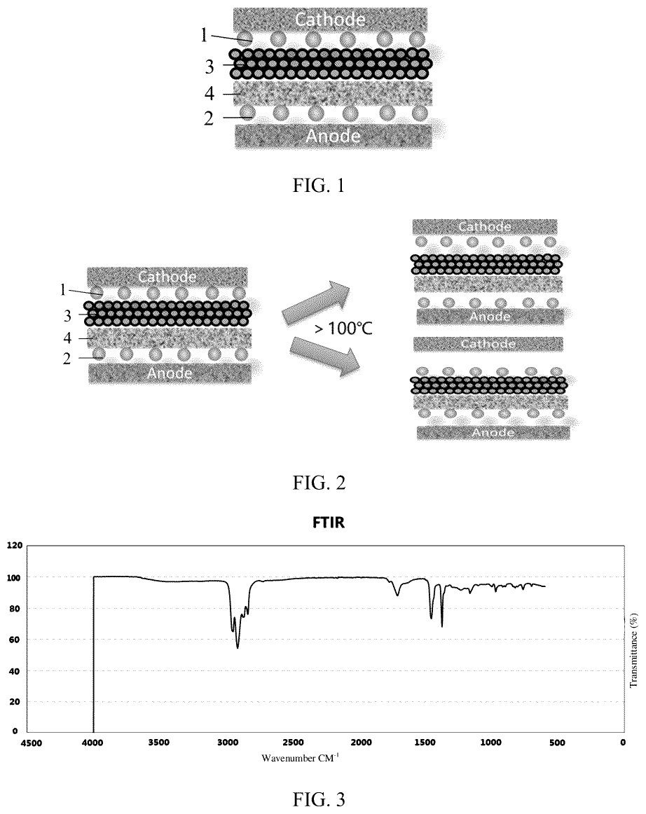

91 g of a core-shell structured polymer binder (a copolymer that has Dᵥ50 of 0.6 μm and that is synthesized from, by mass percentage, 60% styrene, 20% butyl acrylate, and 20% methyl acrylate) was added to a mixer, 0.5 g of sodium carboxymethyl cellulose was added, and a mixture was stirred uniformly. 8.5 g of wetting agent dimethylsiloxane was added, deionized water was added, followed by stirring to adjust a viscosity of the second organic coating slurry to 40 mPa·s with a solid content of 5%. The above second organic coating slurry was uniformly applied to a surface of the separator substrate facing the negative electrode and dried in an oven, with a coating weight of the second organic coating being 1 mg/5000 mm² and a coating thickness of the second organic coating being 1 m. The separator structure is shown in FIG. 1.

### <Preparation of Negative Electrode Plate>

Natural graphite, conductive carbon black, and sodium alginate were mixed at a mass ratio of 70:20:10, deionized water was added as a solvent, and a slurry with a solid content of 45 wt % was prepared. The slurry was stirred uniformly in a vacuum mixer to obtain a negative electrode slurry. The negative electrode slurry was uniformly applied on one surface of a negative electrode current collector copper foil with a thickness of 10 μm, and dried at 90° C., obtaining a negative electrode plate with a negative electrode material layer with a thickness of 100 μm applied to one surface. The above steps were repeated on another surface of the copper foil to obtain a negative electrode plate with the negative electrode material layer applied to two surfaces. After drying at 90° C., the plate was cold-pressed, cut, and welded with tabs to obtain a negative electrode plate of 78 mm×875 mm.

### <Preparation of Positive Electrode Plate>

LiCoO₂, conductive carbon black, and polyvinylidene fluoride were mixed at a mass ratio of 70:20:10, N-methylpyrrolidone (NMP) was added as a solvent, and a slurry with a solid content of 75 wt % was prepared. The slurry was stirred uniformly in a vacuum mixer to obtain a positive electrode slurry. The positive electrode slurry was uniformly applied to one surface of a positive electrode current collector aluminum foil with a thickness of 10 μm, and dried at 90° C., obtaining a positive electrode plate with a positive electrode material layer with a thickness of 100 μm applied to one surface. The above steps were repeated on another surface of the aluminum foil to obtain a positive electrode plate with the positive electrode material applied to two surfaces. After drying at 90° C., the plate was cold-pressed, cut, and welded with tabs to obtain a positive electrode plate of 74 mm×867 mm.

### <Preparation of Electrolyte>

In a glovebox with a dry argon atmosphere, organic solvents EC, PC, and DEC were mixed at a mass ratio of 3:1:3, and lithium salt LiPF₆ was added to the organic solvent, dissolved, and mixed uniformly to obtain an electrolyte. A concentration of the lithium salt was 1 mol/L.

### <Preparation of Lithium-Ion Battery>

The positive electrode plate, separator, and negative electrode plate prepared above were stacked in sequence, with the separator placed between the positive electrode plate and the negative electrode plate for isolation, and wound to obtain an electrode assembly. The electrode assembly was placed into an aluminum-plastic film packaging bag, moisture was removed at 80° C., the prepared electrolyte was injected, and the packaging bag underwent vacuum sealing, standing, formation, degassing, trimming, and the like to obtain a lithium-ion battery.

### Examples 2 to 5

These examples were the same as Example 1, except that a relevant preparation parameter in <Preparation of separator> was adjusted according to Table 1.

### Example 6

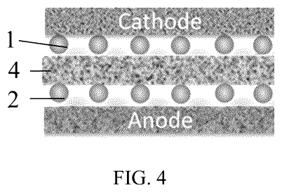

This example was the same as Example 1, except that in <Preparation of separator>, the first organic coating slurry was directly applied to the surface of the separator substrate (5-μm polyethylene (PE)). In other words, the side of the separator facing the positive electrode had no inorganic coating. The separator structure is shown in FIG. 4.

### Examples 7 to 10

These examples were the same as Example 1, except that a relevant preparation parameter in <Preparation of separator> was adjusted according to Table 2.

### Examples 11 to 18

These examples were the same as Example 1, except that a relevant preparation parameter in <Preparation of separator> was adjusted according to Table 3.

### Examples 19 to 21

These examples were the same as Example 1, except that a relevant preparation parameter in <Preparation of separator> was adjusted according to Table 4.

### Examples 22 to 27

These examples were the same as Example 1, except that a relevant preparation parameter in <Preparation of separator> was adjusted according to Table 5.

### Examples 28 to 30

These examples were the same as Example 1, except that a relevant preparation parameter (the coating weight of the second organic coating) in <Preparation of separator> was adjusted according to Table 6.

### Examples 31 to 37

These examples were the same as Example 1, except that a relevant preparation parameter in <Preparation of separator> was adjusted according to Table 7.

### Comparative Example 1

This example was the same as Example 1, except that the separator was prepared according to the following steps.

### <Preparation of Separator>

The separator substrate was 8-μm polyethylene (PE), coated with a 2-μm aluminum oxide ceramic inorganic coating on two sides. Then the two sides on which the inorganic coating was applied was coated with a binder polyvinylidene fluoride (PVDF) with a coating weight of 1.25 mg/5000 mm², and dried.

### Comparative Example 2

This example was the same as Example 1, except that the relevant preparation parameter in <Preparation of separator> was adjusted according to Table 1.

### Comparative Example 3

This example was the same as Example 1, except that the relevant preparation parameter in <Preparation of separator> was adjusted according to Table 1.

The preparation parameters, physical properties, and electrical performance parameters of each example and comparative example are shown in Tables 1 to 7.

TABLE 1

| | | | | | | | Room- |
|---|---|---|---|---|---|---|---|
| | | | | | | Coating | temperature |
| | | | | | | weight | adhesion |
| | | | | Monomer | | of | strength |
| | | | | used | | first | T1 on |
| | | | Polymer | for | Mass | organic | positive |
| | Melting | | monomer | grafting | average | coating | electrode |
| | point | Dᵥ50 | and mass | and mass | molar | (mg/5000 | side |
| | (° C.) | (μm) | percentage | percentage | mass | mm²) | (N/m) |
| Example 1 | 70 | 1 | 10% | 5% maleic | 600000 | 1.5 | 10.1 |
| | | | ethylene + 85% | anhydride | | | |
| | | | propylene | | | | |
| Example 2 | 60 | 1 | 10% | 5% maleic | 600000 | 1.5 | 11.5 |
| | | | ethylene + 85% | anhydride | | | |
| | | | propylene | | | | |
| Example 3 | 80 | 1 | 10% | 5% maleic | 600000 | 1.5 | 9.3 |
| | | | ethylene + 85% | anhydride | | | |
| | | | propylene | | | | |
| Example 4 | 90 | 1 | 10% | 5% maleic | 600000 | 1.5 | 8.6 |
| | | | ethylene + | anhydride | | | |
| | | | 85% | | | | |
| | | | propylene | | | | |
| Example 5 | 100 | 1 | 10% | 5% maleic | 600000 | 1.5 | 8.2 |
| | | | ethylene + | anhydride | | | |
| | | | 85% | | | | |
| | | | propylene | | | | |
| Example 6 | 70 | 1 | 10% | 5% maleic | 600000 | 1.5 | 10.1 |
| | | | ethylene + | anhydride | | | |
| | | | 85% | | | | |
| | | | propylene | | | | |
| Comparative | / | / | / | / | / | / | 11.5 |
| example 1 | | | | | | | |
| Comparative | 50 | 1 | 10% | 5% maleic | 600000 | 1.5 | 12.8 |
| example 2 | | | ethylene + | anhydride | | | |
| | | | 85% | | | | |
| | | | propylene | | | | |
| Comparative | 110 | 1 | 10% | 5% maleic | 600000 | 1.5 | 7.8 |
| example 3 | | | ethylene + | anhydride | | | |
| | | | 85% | | | | |
| | | | propylene | | | | |

| | High- | | High- | Room- | | |
|---|---|---|---|---|---|---|
| | temperature | | temperature | temperature | | |
| | adhesion | | adhesion | adhesion | | |
| | strength | | strength | strength | | |
| | T2 | | T3 | T4 | | |
| | on | | on | on | | |
| | positive | | negative | negative | | Cycling |
| | electrode | | electrode | electrode | Hot-box | capacity |
| | side | | side | side | pass | retention |
| | (N/m) | T2/T1 | (N/m) | (N/m) | rate | rate |
| Example 1 | 2.8 | 0.277 | 18 | 20 | 100% | 88.50% |
| Example 2 | 2.4 | 0.209 | 18 | 20 | 100% | 87.60% |
| Example 3 | 3.6 | 0.387 | 18 | 20 | 80% | 89.20% |
| Example 4 | 5.3 | 0.616 | 18 | 20 | 60% | 89.50% |
| Example 5 | 6.5 | 0.793 | 18 | 20 | 50% | 89.90% |
| Example 6 | 2.8 | 0.277 | 18 | 20 | 100% | 88.40% |
| Comparative | 12.1 | 1.052 | 18 | 20 | 10% | 87.10% |
| example 1 | | | | | | |
| Comparative | 2.1 | 0.164 | 18 | 20 | 60% | 83.30% |
| example 2 | | | | | | |
| Comparative | 7.5 | 0.962 | 18 | 20 | 20% | 84.50% |
| example 3 | | | | | | |

Note:
“/” in Table 1 indicates absence of a related preparation parameter.

TABLE 2

| | | | | | | | Room- | High- | | | |
|---|---|---|---|---|---|---|---|---|---|---|---|
| | | | | | | | temperature | temperature | | | |
| | | | | | | Coating | adhesion | adhesion | | | |
| | | | | Monomer | | weight | strength | strength | | | |
| | | | | used | | of | T1 | T2 | | | |
| | | | Polymer | for | | first | on | on | | | |
| | | | monomer | grafting | Mass | organic | positive | positive | | | Cycling |
| | Melting | | and | and | average | coating | electrode | electrode | | Hot-box | capacity |
| | point | Dᵥ50 | mass | mass | molar | (mg/5000 | side | side | | pass | retention |
| | (° C.) | (μm) | percentage | percentage | mass | mm²) | (N/m) | (N/m) | T2/T1 | rate | rate |
| Example | 70 | 1 | 10% | 5% | 600000 | 1.5 | 10.1 | 2.8 | 0.277 | 100% | 88.50% |
| 1 | | | ethylene + 85% | maleic | | | | | | | |
| | | | propylene | anhydride | | | | | | | |
| Example | 70 | 0.8 | 10% | 5% | 600000 | 1.5 | 12.3 | 5.9 | 0.48 | 60% | 86.80% |
| 7 | | | ethylene + 85% | maleic | | | | | | | |
| | | | propylene | anhydride | | | | | | | |
| Example | 70 | 1.5 | 10% | 5% | 600000 | 1.5 | 10.1 | 2.5 | 0.248 | 100% | 88.40% |
| 8 | | | ethylene + 85% | maleic | | | | | | | |
| | | | propylene | anhydride | | | | | | | |
| Example | 70 | 2 | 10% | 5% | 600000 | 1.5 | 9.4 | 2.3 | 0.245 | 100% | 88.20% |
| 9 | | | ethylene + 85% | maleic | | | | | | | |
| | | | propylene | anhydride | | | | | | | |
| Example | 70 | 2.5 | 10% | 5% | 600000 | 1.5 | 8.5 | 2.1 | 0.247 | 100% | 85.60% |
| 10 | | | ethylene + 85% | maleic | | | | | | | |
| | | | propylene | anhydride | | | | | | | |

TABLE 3

| | | | | | | | Room- | High- | | | |
|---|---|---|---|---|---|---|---|---|---|---|---|
| | | | | | | | temperature | temperature | | | |
| | | | | | | Coating | adhesion | adhesion | | | |
| | | | | Monomer | | weight | strength | strength | | | |
| | | | | used | | of | T1 | T2 | | | |
| | | | Polymer | for | | first | on | on | | | |
| | | | monomer | grafting | Mass | organic | positive | positive | | | Cycling |
| | Melting | | and | and | average | coating | electrode | electrode | | Hot-box | capacity |
| | point | Dᵥ50 | mass | mass | molar | (mg/5000 | side | side | | pass | retention |
| | (° C.) | (μm) | percentage | percentage | mass | mm²) | (N/m) | (N/m) | T2/T1 | rate | rate |
| Example | 70 | 1 | 10% | 5% | 600000 | 1.5 | 10.1 | 2.8 | 0.277 | 100% | 88.50% |
| 1 | | | ethylene + 85% | maleic | | | | | | | |
| | | | propylene | anhydride | | | | | | | |
| Example | 70 | 1 | 5% | / | 600000 | 1.5 | 11.3 | 6.8 | 0.602 | 60% | 87.50% |
| 11 | | | ethylene + 95% | | | | | | | | |
| | | | propylene | | | | | | | | |
| Example | 70 | 1 | 10% | / | 600000 | 1.5 | 10.6 | 3.7 | 0.349 | 80% | 88.10% |
| 12 | | | ethylene + 90% | | | | | | | | |
| | | | propylene | | | | | | | | |
| Example | 70 | 1 | 15% | / | 600000 | 1.5 | 10.2 | 2.6 | 0.255 | 100% | 88.70% |
| 13 | | | ethylene + 85% | | | | | | | | |
| | | | propylene | | | | | | | | |
| Example | 70 | 1 | 20% | / | 600000 | 1.5 | 11.3 | 3.6 | 0.319 | 80% | 87.90% |
| 14 | | | ethylene + 80% | | | | | | | | |
| | | | propylene | | | | | | | | |
| Example | 70 | 1 | 10% | / | 600000 | 1.5 | 11.8 | 4.5 | 0.381 | 70% | 88.10% |
| 15 | | | styrene + 90% | | | | | | | | |
| | | | propylene | | | | | | | | |
| Example | 70 | 1 | 10% | / | 600000 | 1.5 | 12.3 | 4.7 | 0.382 | 70% | 87.50% |
| 16 | | | acrylonitrile + | | | | | | | | |
| | | | 90% propylene | | | | | | | | |
| Example | 70 | 1 | 5% | / | 600000 | 1.5 | 11.4 | 3.5 | 0.307 | 80% | 86.80% |
| 17 | | | acrylonitrile + | | | | | | | | |
| | | | 5% ethylene + | | | | | | | | |
| | | | 90% propylene | | | | | | | | |
| Example | 70 | 1 | 5% styrene + | / | 600000 | 1.5 | 12.6 | 4.8 | 0.381 | 70% | 87.90% |
| 18 | | | 5% ethylene + | | | | | | | | |
| | | | 90% propylene | | | | | | | | |

Note:
“/” in Table 3 indicates absence of a related preparation parameter.

TABLE 4

| | | | | | | | | High- | | | |
|---|---|---|---|---|---|---|---|---|---|---|---|
| | | | | | | | Room- | temperature | | | |
| | | | | | | | temperature | adhesion | | | |
| | | | | | | Coating | adhesion | strength | | | |
| | | | | Monomer | | weight | strength | T2 | | | |
| | | | | used | | of | T1 on | on | | | |
| | | | Polymer | for | Mass | first | positive | positive | | | Cycling |
| | Melting | | monomer | grafting | average | organic | electrode | electrode | | Hot-box | capacity |
| | point | Dᵥ50 | and mass | and mass | molar | coating | side | side | | pass | retention |
| | (° C.) | (μm) | percentage | percentage | mass | (mg/5000 mm²) | (N/m) | (N/m) | T2/T1 | rate | rate |
| Example | 70 | 1 | 10% | 5% | 600000 | 1.5 | 10.1 | 2.8 | 0.277 | 100% | 88.50% |
| 1 | | | ethylene + 85% | maleic | | | | | | | |
| | | | propylene | anhydride | | | | | | | |
| Example | 70 | 1 | 13% | 2% | 600000 | 1.5 | 11.2 | 2.7 | 0.241 | 100% | 87.20% |
| 19 | | | ethylene + 85% | maleic | | | | | | | |
| | | | propylene | anhydride | | | | | | | |
| Example | 70 | 1 | 7% | 8% | 600000 | 1.5 | 12.2 | 3.9 | 0.32 | 90% | 88.40% |
| 20 | | | ethylene + 85% | maleic | | | | | | | |
| | | | propylene | anhydride | | | | | | | |
| Example | 70 | 1 | 4% | 11% | 600000 | 1.5 | 12.5 | 4.8 | 0.384 | 80% | 88.70% |
| 21 | | | ethylene + 85% | maleic | | | | | | | |
| | | | propylene | anhydride | | | | | | | |

TABLE 5

| | | | | | | | | High- | | | |
|---|---|---|---|---|---|---|---|---|---|---|---|
| | | | | | | | Room- | temperature | | | |
| | | | | | | | temperature | adhesion | | | |
| | | | | | | Coating | adhesion | strength | | | |
| | | | | Monomer | | weight | strength | T2 | | | |
| | | | | used | | of | T1 on | on | | | |
| | | | Polymer | for | Mass | first | positive | positive | | | Cycling |
| | Melting | | monomer | grafting | average | organic | electrode | electrode | | Hot-box | capacity |
| | point | Dᵥ50 | and mass | and mass | molar | coating | side | side | | pass | retention |
| | (° C.) | (μm) | percentage | percentage | mass | (mg/5000 mm²) | (N/m) | (N/m) | T2/T1 | rate | rate |
| Example | 70 | 1 | 10% | 5% | 600000 | 1.5 | 10.1 | 2.8 | 0.277 | 100% | 88.50% |
| 1 | | | ethylene + 85% | maleic | | | | | | | |
| | | | propylene | anhydride | | | | | | | |
| Example | 70 | 1 | 10% | 5% | 200000 | 1.5 | 13.1 | 2.5 | 0.191 | 100% | 86.50% |
| 22 | | | ethylene + 85% | maleic | | | | | | | |
| | | | propylene | anhydride | | | | | | | |
| Example | 70 | 1 | 10% | 5% | 300000 | 1.5 | 12.6 | 2.9 | 0.23 | 100% | 86.90% |
| 23 | | | ethylene + 85% | maleic | | | | | | | |
| | | | propylene | anhydride | | | | | | | |
| Example | 70 | 1 | 10% | 5% | 400000 | 1.5 | 12.4 | 3.1 | 0.25 | 100% | 87.50% |
| 24 | | | ethylene + 85% | maleic | | | | | | | |
| | | | propylene | anhydride | | | | | | | |
| Example | 70 | 1 | 10% | 5% | 800000 | 1.5 | 10.3 | 4.7 | 0.456 | 80% | 88.70% |
| 25 | | | ethylene + 85% | maleic | | | | | | | |
| | | | propylene | anhydride | | | | | | | |
| Example | 70 | 1 | 10% | 5% | 1000000 | 1.5 | 8.6 | 6.7 | 0.779 | 60% | 89.10% |
| 26 | | | ethylene + 85% | maleic | | | | | | | |
| | | | propylene | anhydride | | | | | | | |
| Example | 70 | 1 | 10% | 5% | 1100000 | 1.5 | 7.8 | 7.5 | 0.962 | 50% | 87.30% |
| 27 | | | ethylene + 85% | maleic | | | | | | | |
| | | | propylene | anhydride | | | | | | | |

TABLE 6

| | Room- | High- | | | High- | | | |
|---|---|---|---|---|---|---|---|---|
| | temperature | temperature | | | temperature | | | |
| | adhesion | adhesion | | | adhesion | | | |
| | strength | strength | | Coating | strength | | | |
| | T1 on | T2 on | | weight | T3 on | | | |
| | positive | positive | | of second | negative | | Hot- | Cycling |
| | electrode | electrode | | organic | electrode | | box | capacity |
| | side | side | | coating | side | T3- | pass | retention |
| | (N/m) | (N/m) | T2/T1 | (mg/5000 mm²) | (N/m) | T2 | rate | rate |
| Example | 10.1 | 2.8 | 0.277 | 1.0 | 20 | 17.2 | 100% | 88.50% |
| 1 | | | | | | | | |
| Example | 10.1 | 2.8 | 0.277 | 0.75 | 15 | 12.2 | 90% | 89.6% |
| 28 | | | | | | | | |
| Example | 10.1 | 2.8 | 0.277 | 0.60 | 10 | 7.2 | 80% | 91.2% |
| 29 | | | | | | | | |
| Example | 10.1 | 2.8 | 0.277 | 0.45 | 7 | 4.2 | 50% | 92.2% |
| 30 | | | | | | | | |

TABLE 7

| | | | | Monomer | | Coating | Room-temperature adhesion |
|---|---|---|---|---|---|---|---|
| | | | | used | | weight | strength T1 |
| | | | Polymer | for | | of | on |
| | | | monomer | grafting | | first | positive |
| | Melting | Particle | and | and | | organic | electrode |
| | point | size | mass | mass | Molecular | coating (mg/5000 | side |
| | (° C.) | (μm) | percentage | percentage | weight | mm²) | (N/m) |
| Example | 70 | 1 | 10% | 5% | 600000 | 1.5 | 10.1 |
| 1 | | | ethylene + | maleic | | | |
| | | | 85% | anhydride | | | |
| | | | propylene | | | | |
| Example | 70 | 1 | 10% | 5% | 600000 | 0.4 | 7.8 |
| 31 | | | ethylene + | maleic | | | |
| | | | 85% | anhydride | | | |
| | | | propylene | | | | |
| Example | 70 | 1 | 10% | 5% | 600000 | 0.5 | 8.2 |
| 32 | | | ethylene + | maleic | | | |
| | | | 85% | anhydride | | | |
| | | | propylene | | | | |
| Example | 70 | 1 | 10% | 5% | 600000 | 1 | 9.3 |
| 33 | | | ethylene + | maleic | | | |
| | | | 85% | anhydride | | | |
| | | | propylene | | | | |
| Example | 70 | 1 | 10% | 5% | 600000 | 2 | 11.7 |
| 34 | | | ethylene + | maleic | | | |
| | | | 85% | anhydride | | | |
| | | | propylene | | | | |
| Example | 70 | 1 | 10% | 5% | 600000 | 3 | 12.4 |
| 35 | | | ethylene + | maleic | | | |
| | | | 85% | anhydride | | | |
| | | | propylene | | | | |
| Example | 70 | 1 | 10% | 5% | 600000 | 4 | 12.8 |
| 36 | | | ethylene + | maleic | | | |
| | | | 85% | anhydride | | | |
| | | | propylene | | | | |
| Example | 70 | 1 | 10% | 5% | 600000 | 5 | 13.2 |
| 37 | | | ethylene + | maleic | | | |
| | | | 85% | anhydride | | | |
| | | | propylene | | | | |

| | High-temperature | | | |
|---|---|---|---|---|
| | adhesion | | | |
| | strength | | | |
| | T2 | | | |
| | on | | | |
| | positive | | | Cycling |
| | electrode | | Hot-box | capacity |
| | side | | pass | retention |
| | (N/m) | T2/T1 | rate | rate |
| Example | 2.8 | 0.277 | 100% | 88.50% |
| 1 | | | | |
| Example | 2.4 | 0.308 | 100% | 85.60% |
| 31 | | | | |
| Example | 2.7 | 0.329 | 100% | 86.70% |
| 32 | | | | |
| Example | 3.1 | 0.333 | 100% | 87.60% |
| 33 | | | | |
| Example | 4.1 | 0.35 | 80% | 88.90% |
| 34 | | | | |
| Example | 6.5 | 0.524 | 60% | 88.10% |
| 35 | | | | |
| Example | 6.9 | 0.539 | 60% | 87.30% |
| 36 | | | | |
| Example | 7.3 | 0.553 | 60% | 86.50% |
| 37 | | | | |

Refer to Table 1. From Examples 1 to 6 and Comparative example 1, it can be learned that compared with batteries having conventional separators, the lithium-ion batteries in the examples of this application exhibit a higher hot-box pass rate and cycling capacity retention rate, indicating that the lithium-ion batteries prepared with the separators provided by this application have good cycling performance and good safety performance.

From Examples 1 to 6 and Comparative examples 2 and 3, it can be learned that when the melting point of the polymer in the first organic coating is excessively low (for example, in Comparative example 2), although the hot-box pass rate is relatively high, the cycling capacity retention rate is low; and when the melting point of the polymer in the first organic coating is excessively high (for example, in Comparative example 3), both the cycling capacity retention rate and the hot-box pass rate are low. By controlling the melting point of the polymer in the organic coating to be within the range of this application, the lithium-ion battery can achieve both good cycling performance and good safety performance.

Dᵥ50 of the polymer also affects the performance of the lithium-ion battery. A larger Dv50 indicates a larger particle size of the polymer, and with the same weight, a larger particle size results in fewer particles, reducing a contact area between the polymer and the positive electrode, thereby reducing the adhesion strength at room temperature. As the particle size of the polymer increases, the adhesion strength decreases at room temperature, and the adhesion strength further decreases at high temperature, improving the thermal debonding effect. However, if the adhesion strength is excessively low at room temperature, the battery is prone to deformation during cycling, leading to poor cycling performance. From Examples 7 to 10, it can be learned that when Dᵥ50 of the polymer is within the range of this application, preparation of a lithium-ion battery with both good cycling performance and safety performance is facilitated.

The type and mass percentage of the polymer monomer also affect the performance of the lithium-ion battery. From Examples 11 to 18, it can be learned that when the type and mass percentage of polymer monomer are within the ranges of this application, preparation of a lithium-ion battery with both good cycling performance and safety performance is facilitated.

The type and mass percentage of the monomer used for grafting also affect the performance of the lithium-ion battery. From Examples 19 to 21, it can be learned that increasing the amount of polar grafting monomer can improve cycling performance, as polar groups can form chemical bonds with the positive electrode surface at high temperature, increasing adhesion strength. Therefore, an excessively large amount of polar grafting monomer can affect the hot-box pass rate. When the type and mass percentage of monomer used for grafting are within the ranges of this application, preparation of a lithium-ion battery with both good cycling performance and safety performance is facilitated.

The molecular weight of the polymer also affects the performance of the lithium-ion battery. From Examples 22 to 27, it can be learned that, with other factors unchanged, a lower molecular weight makes the polymer more likely to melt at high temperature, resulting in a better debonding effect. However, if the molecular weight is excessively low, the polymer has high fluidity during coating, easily entering the pores of the separator, leading to pore clogging and poor cycling. Additionally, a higher molecular weight makes the polymer less likely to melt, or makes the polymer take longer to reach a molten state. For example, at 140° C., a polymer with a high molecular weight takes longer to reach an adhesion strength state for melting, while the battery accumulates heat rapidly, potentially reaching thermal runaway or even exploding in a short time. Therefore, the battery may catch fire or explode before the first organic coating melts and the separator detaches from the positive electrode plate. When the molecular weight of the polymer is within the range of this application, preparation of a lithium-ion battery with both good cycling performance and safety performance is facilitated.

The second organic coating and the high-temperature adhesion strength of the negative electrode plate also affect the performance of the lithium-ion battery. From Examples 28 to 30, it can be learned that when a difference between the high-temperature adhesion strength of the second organic coating to the negative electrode plate and the high-temperature adhesion strength of the first organic coating to the positive electrode plate is controlled within the range of this application, a lithium-ion battery with both good cycling performance and safety performance can be obtained.

The coating weight of the first organic coating also affects the performance of the lithium-ion battery. From Examples 31 to 37, it can be learned that when the coating weight of the first organic coating is within the range of this application, preparation of a lithium-ion battery with both good cycling performance and safety performance is facilitated.

The above descriptions are merely preferred embodiments of this application and are not intended to limit this application. Any modifications, equivalent replacements, improvements, and the like made within the spirit and principles of this application shall fall within the protection scope of this application.

What is claimed is:

1. A secondary battery, comprising a positive electrode plate, a negative electrode plate, and a separator; wherein the separator is provided with a first organic coating on a surface facing the positive electrode plate, and the separator is provided with a second organic coating on a surface facing the negative electrode plate; wherein the first organic coating comprises a polymer, and a melting point of the polymer is in a range of 60° C. to 100° C.

2. The secondary battery according to claim 1, wherein the melting point of the polymer is in a range of 60° C. to 90° C.

3. The secondary battery according to claim 2, wherein the melting point of the polymer is in a range of 60° C. to 80° C.

4. The secondary battery according to claim 2, wherein the melting point of the polymer is in a range of 70° C. to 80° C.

5. The secondary battery according to claim 1, wherein Dᵥ50 of the polymer is in a range of 0.8 μm to 2 μm.

6. The secondary battery according to claim 5, wherein Dᵥ50 of the polymer is in a range of 1.0 μm to 1.5 μm.

7. The secondary battery according to claim 1, wherein the polymer comprises a polymer of at least one monomer selected from the group consisting of ethylene, propylene, vinylidene fluoride, acrylic acid, acrylate, styrene, acrylonitrile, maleic anhydride, vinyl chloride, and chloropropene; and the polymer is a homopolymer, a copolymer, or a blend.

8. The secondary battery according to claim 1, wherein the polymer comprises a graft copolymer; wherein a monomer of a polymer backbone in the graft copolymer comprises at least one selected from the group consisting of ethylene, propylene, vinylidene fluoride, acrylic acid, acrylate, styrene, acrylonitrile, maleic anhydride, vinyl chloride, and chloropropene; and a monomer used for grafting in the graft copolymer comprises at least one selected from the group consisting of maleic anhydride, acrylate, and acrylic acid.

9. The secondary battery according to claim 8, wherein based on a total mass of the polymer, a proportion of the monomer used for grafting is 1% to 10%.

10. The secondary battery according to claim 1, wherein a mass average molar mass of the polymer is 300000 to 1000000.

11. The secondary battery according to claim 1, wherein a room-temperature adhesion strength at 25° C. between the first organic coating and a positive electrode active material layer on the positive electrode plate is T1, and a high-temperature adhesion strength at 130° C. between the first organic coating and the positive electrode active material layer on the positive electrode plate is T2, wherein 0≤T2/T1≤0.8.

12. The secondary battery according to claim 11, wherein T1 is 7 N/m to 13 N/m, and T2 is 1 N/m to 3 N/m.

13. The secondary battery according to claim 11, wherein a high-temperature adhesion strength at 130° C. between the second organic coating and a negative electrode active material layer on the negative electrode plate is T3, wherein T3−T2≥5 N/m.

14. The secondary battery according to claim 11, wherein a high-temperature adhesion strength at 130° C. between the second organic coating and a negative electrode active material layer on the negative electrode plate is T3, wherein T3−T2≥12 N/m.

15. The secondary battery according to claim 1, wherein a coating weight of the first organic coating is 0.5 mg/5000 mm² to 3 mg/5000 mm².

16. The secondary battery according to claim 15, wherein the coating weight of the first organic coating is 0.5 mg/5000 mm² to 1.5 mg/5000 mm².

17. The secondary battery according to claim 1, wherein a coating thickness of the first organic coating is 0.5 μm to 5 μm.

18. The secondary battery according to claim 1, wherein an inorganic coating is provided between a separator substrate and the first organic coating.

19. The secondary battery according to claim 18, wherein the inorganic coating comprises a ceramic; and the ceramic comprises at least one selected from the group consisting of aluminum oxide, boehmite, titanium dioxide, silicon dioxide, zirconium dioxide, tin dioxide, magnesium hydroxide, magnesium oxide, zinc oxide, barium sulfate, boron nitride, and aluminum nitride.

20. An electronic device, comprising a secondary battery, the secondary battery comprising a positive electrode plate, a negative electrode plate, and a separator; wherein the separator is provided with a first organic coating on a surface facing the positive electrode plate, and the separator is provided with a second organic coating on a surface facing the negative electrode plate; wherein the first organic coating comprises a polymer, and a melting point of the polymer is 60° C. to 100° C.
